(19) United States
(12) Patent Application Publication
(10) Pub. No.: US 2004/0057154 A1
(43) Pub. Date: Mar. 25, 2004

(54) Magnetic head having first core and second core bonded together and manufacturing method therefor

(75) Inventors: Katsuya Kikuiri, Niigata-ken (JP); Hideo Itakura, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/656,602

(22) Filed: Sep. 5, 2003

(30) Foreign Application Priority Data
Sep. 24, 2002 (JP) 2002-276923

(51) Int. Cl. G11B 5/127

(52) U.S. Cl. 360/125

(57) ABSTRACT

A magnetic head and a manufacturing method for the same are provided. An abutting plane is formed on a first core, and the abutting plane is butted to a bonding surface of a second core. This allows the first core and the second core to be brought partly into surface contact with each other, and the abutting plane to be planarly machined with high accuracy. Hence, the planar bondability of the first core and the second core can be improved, and the bonding strength can be uniformly enhanced.

### BACKGROUND OF THE INVENTION

1. Field of the Invention

The present invention relates to a magnetic head primarily used with a magnetic recording/reproducing apparatus of video equipment for recording/reproducing recording signals onto/from magnetic tape or a data magnetic recording/reproducing apparatus for a computer. More particularly, the present invention relates to a magnetic head capable of improving planar bondability of a first core and a second core and also capable of providing evenly improved bonding strength, and a manufacturing method for the same.

2. Description of the Related Art

In a magnetic recording apparatus in video equipment or a magnetic recording/reproducing apparatus or the like for storing data for a computer, a magnetic head is mounted on a rotary drum of a rotating head apparatus, and a magnetic tape runs in contact with the rotary drum along a helical track, and information is recorded onto a magnetic tape by helical scanning as the rotary drum rotates.

Recently, in magnetic recording/reproducing apparatuses of video equipment, magnetic recording/reproducing apparatuses for storing data for computers, or other similar apparatuses, efforts have been focused on making further narrower tracks with reduced track widths or using higher frequencies to achieve recording of information onto a magnetic recording medium with a higher density. To accomplish narrower tracks, a track width Tw of a magnetic gap must be decreased.

To achieve such a narrower track, the use of a thin-film magnetic head formed by a thin film forming process has been proposed.

FIG. 16 is a perspective view showing an example of a magnetic head using a conventional thin-film magnetic head. The magnetic head shown in FIG. 16 has a reproducing magneto-resistive (MR) thin-film magnetic head 2, a recording inductive head 3 and an insulating layer 6 serving as a protective film, which are deposited on a first core 1. A second core 5 is bonded onto the insulating layer 6 by an adhesion layer 4. Reference numeral 7 denotes electrodes.

In the magnetic head shown in FIG. 16, entire bonding surfaces 1a and 5a of the first core 1 and the second core 5, respectively, are planar. The bonding surfaces 1a and 5a are bonded to each other by the adhesion layer 4. However, the bonding surfaces 1a and 5a of the first core 1 and the second core 5, respectively, have large areas, making it difficult to machine the bonding surfaces 1a and 5a to planar surfaces with high accuracy. This tends to lead to failure of highly accurate planar bonding between the bonding surfaces 1a and 5a of the first core 1 and the second core 5. Hence, there has been a problem in that the poor planar bondability frequently results in uneven thickness of the adhesion layer 4 between the bonding surfaces 1a and 5a, causing deteriorated bonding strength.

Furthermore, in the magnetic head shown in FIG. 16, the adhesion layer 4 between the first core 1 and the second core 5 is exposed on a medium opposing surface H2A. If, therefore, magnetic particles come off a magnetic tape when the magnetic tape slides against the medium opposing surface H2A, the magnetic particles adhere to the adhesion layer 4 exposed on the medium opposing surface H2A, leading to deteriorated characteristics of the magnetic head.

FIG. 17 shows a magnetic head shown in FIG. 1 of Japanese Unexamined Patent Application Publication No. 2000357304 (hereinafter referred to as “Patent Document 1”). FIG. 17 is a partial perspective view of the magnetic head. The components assigned the same reference numerals as those in FIG. 16 denote the same components shown in FIG. 16.

According to Patent Document 1, the thickness of the adhesion layer 4 in the tape traveling direction (direction Z in the figure) increased toward a height direction (direction Y in the figure) from a medium opposing surface H3A. It is described that the adhesion layer 4 is not exposed on the medium opposing surface H3A.

According to Patent Document 1, in order to gradually increase the thickness of the adhesion layer 4 in the height direction, a groove 8 is formed in the bonding surface 1a of the first core 1 (referred to as a substrate in the publication) that is in contact with the second core 5, the groove 8 gradually becoming deeper in the height direction as the distance from the medium opposing surface H3A increases. In addition, a groove 9 is formed in the bonding surface 5a of the second core 5 (referred to as a protective substrate in the publication) that is in contact with the first core 1, the groove 9 gradually becoming deeper in the height direction as the distance from the medium opposing surface H3A increases. An adhesive agent is injected between the grooves 8 and 9 to gradually increase the thickness of the adhesion layer 4 in the height direction.

The magnetic head described in Patent Document 1, however, poses the following problem. First, when the first core 1 and the second core 5 are provided with the grooves 8 and 9 that gradually become deeper in the height direction or direction Y in the drawing as the distance from the medium opposing surface H3A increases, as shown in FIG. 17, then the first core 1 and the second core 5 will not have any portion that would be in surface contact when they are abutted against each other in a manufacturing process. This prevents the first core 1 and the second core 5 from being positioned and bonded with high accuracy. Especially because the first core 1 and the second core 5 must be supported with high accuracy by jigs shown in FIG. 17 until the adhesion layer 4 is fixed. This requires highly accurate support of the jigs, inevitably leading to an extremely complicated manufacturing process.

Furthermore, since the adhesion layer 4 is formed to become thicker in the height direction, so that the bonding strength of the adhesion layer 4 is not even in the height direction. The bonding strength near the medium opposing surface H3A where the adhesion layer 4 is thin is particularly low. At a height side where the adhesion layer 4 is thick, the bonding strength tends to decrease if the adhesion layer 4 is excessively thick, because the bonding strength is the strength of a resin itself.

Thus, in the magnetic head according to Patent Document 1, it is impossible to bond the first core 1 and the second core 5 with high accuracy, and the bonding strength tends to be uneven and poor.

### SUMMARY OF THE INVENTION

Accordingly, the present invention has been made with a view toward solving the problem with the prior art described above, and it is an object of the present invention to provide a magnetic head that permits the planar bondability of a first core and a second core, in particular, to be improved and allows bonding strength to be evenly improved, and a manufacturing method for the same.

To this end, according to one aspect of the present invention, a magnetic head is provided, which includes a first core equipped with a thin film magnetic head, and a second core bonded to a surface of the first core whereon the thin film magnetic head is formed, a magnetic gap of the thin film magnetic head being exposed on a medium opposing surface of the first core and the second core, wherein a bonding surface of at least one of the first core and the second core is provided with at least one abutting plane that juts out toward the other bonding surface and a groove formed to have a predetermined depth with a step provided between itself and the abutting plane, the abutting plane and the bonding surface of the other core are butted against each other, an adhesion layer of a predetermined thickness is provided at least between the groove and the bonding surface of the other core, and the first core and the second core are bonded.

Thus, the abutting plane partly jutting out is formed on the bonding surface of at least one of the first core and the second core and the abutting plane is butted against the bonding surface of the other core, allowing the first core and the second core to be partly in surface contact. Moreover, the planar machining of the abutting plane can be accomplished with high accuracy, so that the planar bondability of the first core and the second core can be improved.

The groove formed with the step provided between itself and the abutting plane has a predetermined depth, and the adhesion layer of a predetermined thickness is formed between the groove and the bonding surface of the other core. This arrangement allows the adhesion layer to have even bonding strength, making it possible to firmly bond the first core and the second core.

Thus, the abutting plane is formed on a part of the bonding surface, so that more accurate planar machining than that in the conventional example shown in FIG. 16 can be accomplished. Hence, the planar bondability can be improved, allowing the first core and the second core to be bonded with uniform and greater bonding strength.

Preferably, the abutting plane is formed such that it includes the region formed on the first core wherein the thin film magnetic head is formed. This arrangement makes it possible to prevent the adhesion layer from being exposed on the medium opposing surface, thus solving the problem of adhesion or the like of magnetic particles to the adhesion layer. Moreover, since the groove is not formed in the region where the thin film magnetic head is formed, the thin film magnetic head is not damaged when the groove is formed. Thus, a thin film magnetic head with outstanding reproducing and recording characteristics can be secured.

Preferably, the thickness of the adhesion layer ranges from 0.05 μm to 0.3 μm. The experimental results to be discussed hereinafter have revealed that a core transverse rupture strength of 2N or more can be obtained even in an adverse environment with high humidity.

Preferably, thin film magnetic head is formed to have an MR thin film magnetic head.

Preferably, the thin film magnetic head and the first core are covered with a protective film made of an insulating material, and the front surface of the protective film provides the bonding surface.

The adhesion layer is preferably formed of an epoxy-based adhesive agent or a low-melting, glass-based adhesive agent. The heating temperature required for curing the epoxy-based adhesive agent or the like is 300° C. or less. The upper limit temperature that the MR thin film magnetic head can survive in the curing process is about 300° C. at the most; therefore, using an epoxy-based adhesive agent for the adhesion layer makes it possible to adequately prevent deterioration of the reproducing characteristic of the MR thin film magnetic head.

According to another aspect of the present invention, a manufacturing method for a magnetic head is provided, the method including the steps of (a) forming a plurality of thin film magnetic heads on a first substrate, then cutting the first substrate into a bar with a plurality of thin film magnetic heads aligned thereon in the longitudinal direction to form a first bar, (b) cutting a second substrate into a bar to form a second bar, (c) defining the surface of the first bar whereon the thin film magnetic heads are formed as the surface to be bonded to the second bar, protuberantly forming at least one or more abutting planes on the boding surface of at least one of the first bar or the second bar at positions where they will remain in cores when the bars are cut into individual cores in a subsequent step, and forming a groove to a predetermined depth with a step provided between itself and the abutting plane, (d) butting the abutting plane formed on at least one bar against the bonding surface of the other bar, setting the bars parallel to each other, and forming an adhesion layer of a predetermined thickness between the groove formed in at least one bar and the bonding surface of the other bar to bond the first bar and the second bar, and (e) cutting the first bar and the second bar into cores between the individual thin film magnetic heads to produce a magnetic head having the first core and the second core bonded through the intermediary of the adhesion layer and a magnetic gap of the thin film magnetic head being exposed on the medium opposing surface of the first core and the second core.

As set forth above, in step (c), the abutting plane is protuberantly formed on the bonding surface of at least one of the first bar and the second bar, and the groove is formed to a predetermined depth with a step provided between itself and the abutting plane. With this arrangement, the abutting plane of one bar and the bonding surface of the other bar can be butted against each other to secure surface contact in step (d) described above. Moreover, the abutting plane can be formed in a predetermined small area, so that the abutting plane can be machined with high accuracy, making it possible to improve the planar bondability of the abutting plane of one bar and the bonding surface of the other bar. In addition, the surface-abutting of the abutting plane against the bonding surface allows the first bar and the second bar to be stably disposed in parallel, and the adhesion layer of the predetermined thickness can be formed in the groove between the first bar and the second bar. This makes it possible to easily and properly fabricate a magnetic head with enhanced bonding strength.

Preferably, the abutting plane is formed in step (c) described above such that it includes the region wherein the thin film magnetic heads of the first bar are provided.

Preferably, the abutting plane is formed in each region wherein the thin film magnetic heads are formed, and the groove formed between the abutting planes is exposed up to the front end surface of the first bar that will provide a medium opposing surface. This prevents the groove from being formed in the region wherein the thin film magnetic heads are formed, making it possible to properly protect the thin film magnetic heads from damage caused by forming the groove. In addition, since the groove is partly open at the front end surfaces of the first bar and the second bar, when the first bar and the second bar are pressed against each other, an adhesive agent injected into the groove between the first bar and the second bar will evenly spread in the groove due to the capillary phenomenon or the like, allowing the first bar and the second bar to be firmly bonded and fixed. Alternatively, the first bar and the second bar may be butted against each other and positioned, then an adhesive agent may be injected into the groove exposed at the front end surfaces.

Alternatively, in step (c) described above, the abutting planes may be formed in a part of the region between the thin film magnetic heads arranged lengthwise on the first bar. The abutting plane formed in a part of the region between the thin film magnetic heads may be a dummy pad positioned on a cutting line for cutting the first bar and the second bar into cores in step (e) described above and completely removed or partly removed in the cutting step.

Preferably, the groove is formed to a depth ranging from 0.05 μm to 0.3 μm in step (c) above, and the adhesion layer formed in step (d) above is formed to a thickness ranging from 0.05 μm to 0.3 μm.

Preferably, an epoxy-based adhesive agent or a lowmelting, glass-based adhesive agent is selected as an adhesive agent in step (d) above.

### BRIEF DESCRIPTION OF THE DRAWINGS

FIG. 1 is a perspective view of a magnetic head according to an embodiment of the present invention;

FIG. 2 is a perspective view of a first core shown in FIG. 1;

FIG. 3 is a partial front view of a different first core from that shown in FIG. 2;

FIG. 4 is a partial sectional view of the magnetic head shown in FIG. 1 observed from a medium opposing surface;

FIG. 5 is a top plan view of a rotating-head magnetic recording/reproducing apparatus using the magnetic head shown in FIG. 1;

FIG. 6 is a process diagram illustrating a manufacturing method for the magnetic head shown in FIG. 1;

FIG. 7 is another process diagram illustrating the manufacturing method for the magnetic head shown in FIG. 1;

FIG. 8 is still another process diagram illustrating the manufacturing method for the magnetic head shown in FIG. 1;

FIG. 9 is yet another process diagram illustrating the manufacturing method for the magnetic head shown in FIG. 1;

FIG. 10 is a further process diagram illustrating the manufacturing method for the magnetic head shown in FIG. 1;

FIG. 11 is another process diagram illustrating the manufacturing method for the magnetic head shown in FIG. 1;

FIG. 12 is a diagram illustrating an experimental method for measuring a preferable thickness range of an adhesion layer;

FIG. 13 is a view of the assembly shown in FIG. 12 observed from a direction indicated by an arrow I;

FIG. 14 is a graph showing a relationship between the thickness of the adhesion layer and the transverse rupture strength of cores immediately after a first core and a second core are bonded;

FIG. 15 is a graph showing a relationship between the thickness of the adhesion layer and the transverse rupture strength of the cores after the first core and the second core bonded by the adhesion layer are left for 72 hours in an environment wherein the room temperature is 40° C. and humidity is 95%;

FIG. 16 is a perspective view of a conventional magnetic head; and

FIG. 17 is a perspective view showing a conventional magnetic head having a different construction from that shown in FIG. 16.

### DESCRIPTION OF THE PREFERRED EMBODIMENTS

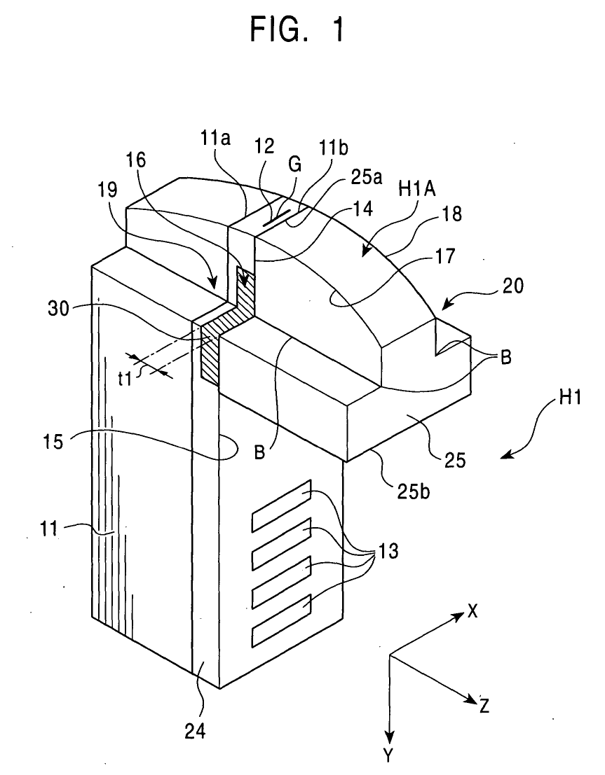

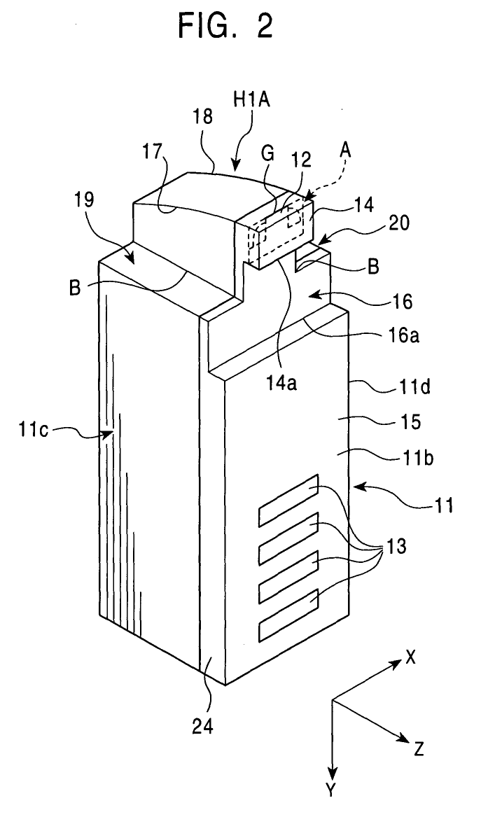

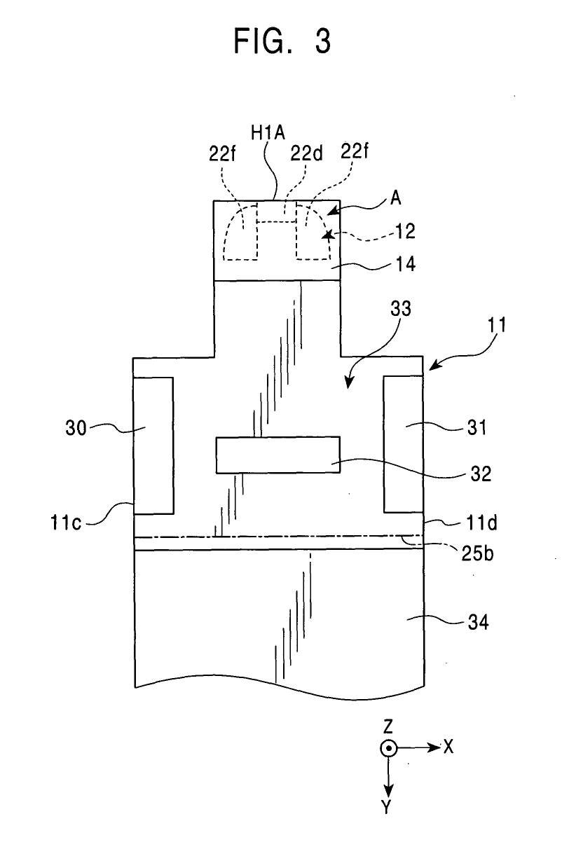

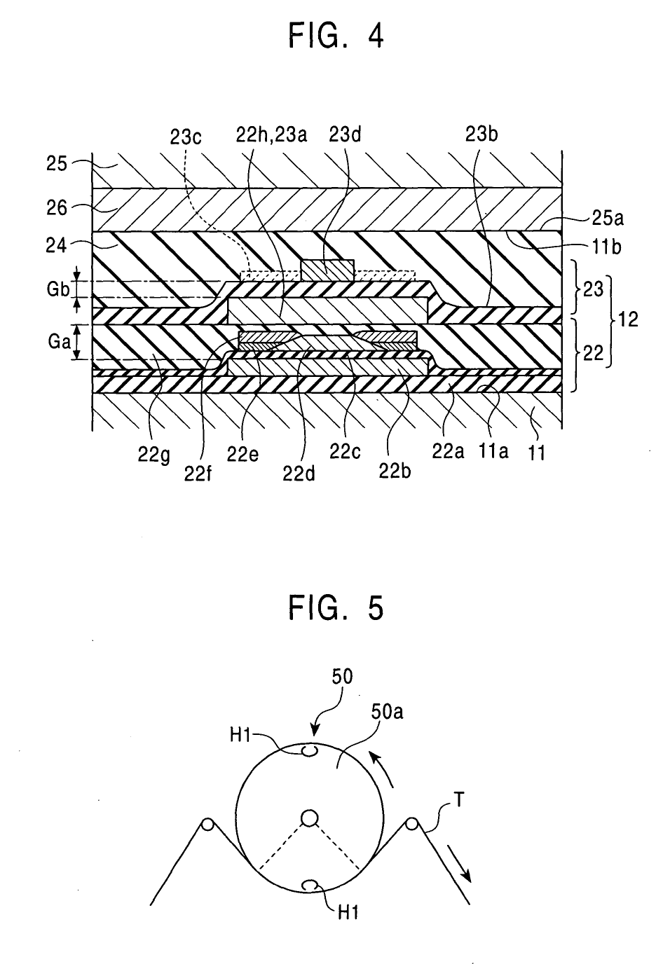

FIG. 1 a perspective view of a magnetic head according to a first embodiment of the present invention. FIG. 2 is a perspective view of a first core of the magnetic head shown in FIG. 1, the first core being observed from the surface whereon thin film magnetic heads are formed. FIG. 3 is a partial front view of a first core according to a second embodiment observed from the surface whereon thin film magnetic heads are formed. FIG. 4 is a partial sectional view of the magnetic head shown in FIG. 1 observed from a medium opposing surface.

A magnetic head H1 is a sliding magnetic head constituting a magnetic recording/reproducing apparatus of video equipment for recording/reproducing recording signals onto/from, for example, a magnetic tape, or a data magnetic recording/reproducing apparatus for a computer.

The sliding type thin film magnetic head shown in FIG. 1 can be installed on a rotating head apparatus, as shown in FIG. 5.

In a rotating head apparatus 50 provided on a magnetic recording/reproducing apparatus shown in FIG. 5, a fixed drum (not shown) is secured, a rotary drum 50a coaxial with the fixed drum is rotatively supported on the fixed drum, and the rotary drum 50a is rotatively driven in the direction of the arrow by motor power. A magnetic tape T, which is a magnetic recording medium, is wound onto the rotating head apparatus 50 at a predetermined angle along a helical track to run in the direction of the arrow. Meanwhile, the rotary drum 50a rotates, and sliding type thin film magnetic heads H1 mounted on the rotary drum 50a scan the magnetic tape T.

In FIG. 5, a pair of sliding type thin film magnetic heads H1 is mounted on the rotary drum 50a at positions where they oppose each other. Alternatively, however, three or more sliding type thin film magnetic heads H1 may be installed.

In the magnetic head H1, thin film magnetic heads 12 and an insulating layer 24 composed of Al₂O₃ to serve as a protective film are deposited by a thin film forming process, through the intermediary of a ground layer composed of an insulating material, such as Al₂O₃ or SiO₂, on a surface 11a of a first core 11 composed of nonmagnetic alumina-titanium carbide, the surface 11a having magnetic reproducing heads formed thereon.

Referring to FIG. 4, the thin film magnetic head 12 is a compound thin film magnetic head combining an MR thin film magnetic head 22 and an inductive head 23.

The MR thin film magnetic head 22 includes a lower shielding layer 22b, a lower gap layer 22c, an MR element layer 22d, a hard bias layer 22e, electrode layers 22f, an upper gap layer 22g and an upper shielding layer 22h, which are deposited, via an insulating layer, which is the ground layer, on the first core 11 composed of alumina-titanium carbide by a thin film forming process. The portion sandwiched by the lower shielding layer 22b and the upper shielding layer 22h and opposing a magnetic tape provides a magnetic gap Ga of the MR thin film magnetic head 22.

Referring to FIG. 4, the recording inductive head 23 provided on the MR thin film magnetic head 22 includes a gap layer 23b, a coil layer 23c and an upper core layer 23d deposited on the lower core layer 23a also serving as an upper shielding layer by the thin film forming process as in the case of the MR thin film magnetic head 22. The portion sandwiched by the lower core layer 23a and the upper core layer 23d and opposing a magnetic tape provides a magnetic gap Gb of the inductive head 23.

The lower gap layer 22c, the upper gap layer 22g and the gap layer 23b are formed of Al₂O₃ or SiO₂. The lower shielding layer 22b, the upper shielding layer 22h (the lower core layer 23a) and the upper core layer 23d are formed of a soft magnetic material, such as Permalloy. The electrode layer 22f and the coil layer 23c are formed of an electrically conductive material, such as Cu. The hard bias layer 22e is formed of a hard magnetic material, such as PtCo.

The MR element layer 22d is formed of a GMR element or AMR element, such as a spin-valve type thin film element.

The insulating layer 24 functioning as a protective film is deposited on the inductive head 23.

As shown in FIGS. 1 and 4, the second core 25 is bonded to the first core 11 such that it faces toward the surface 11a on which the thin film magnetic head 12 is formed. The second core 25 is composed of alumina-titanium carbide or the like, as in the case of the first core 11. Referring to FIG. 4, the insulating layer 26, which is a protective film composed of an insulating material, such as Al₂O₃, is formed to a thin film on the surface of the second core 25 that opposes the first core 11 by, for example, sputtering or the like. The insulating layer 26 is formed by, for example, sputtering, and the sputtering enhances the force of bonding between the second core 25 and the insulating layer 26. This makes it possible to protect the second core 25 from damage at the interface between the second core 25 and the insulating layer 26 when the magnetic tape slides on a medium opposing surface H1A.

In the embodiment shown in FIGS. 1 and 4, the front surface of the insulating layer 24 formed on the surface 11a of the first core 11 with the thin film magnetic heads 12 formed thereon provides a bonding surface 11b to be bonded to the second core 25. The front surface of the insulating layer 26 formed on the second core 25 provides a bonding surface 25a to be bonded to the first core 11.

Referring to FIG. 1, the medium opposing surface H1A of the first core 11 and the second core 25 is curved in a radius shape in direction Z in the drawing, which is the tape sliding direction. A magnetic gap G of the thin film magnetic head 12 is exposed at the medium opposing surface H1A, and the magnetic gap G is positioned substantially at the middle of the medium opposing surface H1A in direction Z in the drawing. The magnetic gap G in this embodiment refers to both the magnetic gap Ga of the MR thin film magnetic head 22 and the magnetic gap Gb of the inductive head 23 shown in FIG. 4.

As shown in FIG. 1, the length of the first core 11 in direction Y in the drawing, which will be referred to as “the height direction” in some cases hereinafter, is set to be greater than the length of the second core 25 in direction Y. The front surface of the insulating layer 24 formed on the first core 11 extends in direction Y beyond a rear end surface 25b of the second core 25 at the opposite side of the medium opposing surface H1A. Furthermore, a plurality of electrodes 13 is provided on the front surface of the insulating layer 24 of the first core 11 that juts out in direction Y beyond the second core 25. The electrodes 13 is connected in conduction with the MR thin film magnetic head 22 and the inductive head 23 by a leading layer or the like (not shown) inside the insulating layer 24. Currents flow from the electrodes 13 to the MR thin film magnetic head 22 and the inductive head 23.

Referring to FIGS. 1 and 2, the first core 11 and the second core 25 are provided with recessed portions 19 and 20, respectively, formed via steps B in the height direction (direction Y). The recessed portions 19 and 20 extend from both side ends 17 and 18 in the width direction (direction X) of the medium opposing surface H1A. Due to the recessed portions 19 and 20, the medium opposing surface H1A of the first core 11 and the second core 25 projects beyond the rest of the assembly. With this arrangement, the magnetic gap G exposed at the medium opposing surface H1A comes in contact with the magnetic tape sliding on the medium opposing surface H1A under an appropriate surface pressure, making it possible to properly improve frequency characteristics or the like of the magnetic head.

Referring to FIG. 2, the bonding surface 11b of the first core 11 is provided with abutting planes 14 and 15 jutting out in direction Z toward a bonding surface 25a of the second core 25. For convenience sake, the abutting plane 14 will be referred to as “the first abutting plane” and the abutting plane 15 as “the second abutting plane.”

As shown in FIG. 2, the first abutting plane 14 is formed in a region A of the thin film magnetic head 12. FIG. 3 shows an embodiment different from the one shown in FIG. 2. However, the position, shape, etc. of the first abutting plane 14 of the embodiment shown in FIG. 3 are the same as those shown in FIG. 2; therefore, the explanation of the first abutting plane 14 may use FIG. 3, as necessary.

FIGS. 2 and 3 show the MR element layer 22d and the electrode layers 22f located on both sides of the MR element layer 22d of the thin film magnetic head 12 observed from the bonding surface 11b of the first core 11 (the MR element layer 22d and the electrode layers 22f being indicated by the dashed line in the drawings. The term “region A” means a planar region having a size for including the denotation of all layers of the shielding layers 22b and 22h, the MR element layer 22d, the bias layer 22e, the electrode layers 22f, the coil layer 23c, the core layers 23a and 23d, which constitute the thin film magnetic head 12. Among these layers, the electrode layers 22f, for example, have the largest planar areas, so that FIGS. 2 and 3 show the planar shape of the electrode layers 22f, in particular, to indicate the region A.

The first abutting plane 14 is formed to extend in direction Y from the medium opposing surface H1A to have a predetermined width (the dimension in direction X) and a predetermined length (the dimension in direction Y) so that the area of the abutting plane 14 completely includes the region A of the thin film magnetic head 12.

Referring to FIG. 2, a groove 16 is formed to a predetermined depth, via a step, from a surface 14a of the first abutting plane 14, the surface 14a being on the farther end from the medium opposing surface H1A. In this embodiment, the groove 16 is formed to have a predetermined length in direction Y in the drawing and to extend from a left end 11c to a right end lid of the first core 11.

As shown in FIG. 2, the first core 11 is provided with a second abutting plane 15 that extends, via a step, from an end 16a of the groove 16 on the farther end from the medium opposing surface H1A in direction Y and juts out toward the bonding surface 25a of the second core 25. The foregoing electrodes 13 are formed on the second abutting plane 15.

The first abutting plane 14 and the second abutting plane 15 are formed to have the same height.

In this embodiment, the bonding surface 25a of the second core 25 is not provided with the abutting planes 14, 15 and the groove 16 formed on the bonding surface 11b of the first core 11. The entire bonding surface 25a of the second core 25 is planar.

According to this embodiment, the surfaces of the abutting planes 14 and 15 and the bonding surface 25a of the second core 25 are butted to bond the first core 11 and the second core 25. As shown in FIG. 1, the entire surface of the first abutting plane 14 is butted to the bonding surface 25a of the second core 25, while only a part of the second abutting plane 15 is butted to the bonding surface 25a of the second core 25.

At this time, the gap shown in FIG. 1 is formed between the groove 16 formed in the first core 11 and the bonding surface 25a of the second core 25, and an adhesion layer 30 is provided in the gap.

As described above, the groove 16 is formed to have a predetermined depth, and the abutting planes 14 and 15 formed on the first core 11 are formed to the same height. These abutting planes 14 and 15 and the bonding surface 25a of the second core 25 are butted to each other so that the first core 11 and the second core 25 are disposed in parallel to each other and the gap is formed to a predetermined thickness between the groove 16 and the bonding surface 25a of the second core 25. Hence, the adhesion layer 30 buried in the gap is also formed to have a predetermined thickness.

The magnetic head shown in FIGS. 1 and 2 allows the first abutting plane 14 formed on the first core 11 to have a smaller predetermined area and the planar machining of the first abutting plane 14 to be accomplished with high accuracy. This makes it possible to improve the planar bondability of the first core 11 and the second core 25 and also to achieve uniformly enhanced bonding strength at any portion of the adhesion layer 30 since the adhesion layer 30 is formed to a predetermined thickness, as previously described. Moreover, the second abutting plane 15 formed on the first core 11 is formed to have a larger area than that of the first abutting plane 14, whereas only a part of the second abutting plane 15 is butted to the bonding surface 25a of the second core 25. This means that highly accurate planar machining is not required for the entire second abutting plane 15, and the planar bondability of the first core 11 and the second core 25 can be further improved by carrying out high-accuracy planar machining only on the portion of the second abutting plane 15 that will be butted to the second core 25.

As in the case of the embodiment shown in FIG. 1, the first abutting plane 14 is preferably formed to include the region A formed on first core 11 wherein the thin film magnetic head 12 is formed. This arrangement prevents the thin film magnetic head 12 from being damaged by etching or the like when the groove 16 is formed, so that deterioration of the reproducing characteristic or the recording characteristic of the thin film magnetic head 12 can be prevented. In addition, although an edge of the first abutting plane 14 is exposed on the medium opposing surface H1A, the adhesion layer 30 formed in the groove 16 is located at a position retreated in the height direction from the medium opposing surface H1A, so that the adhesion layer 30 is not exposed on the medium opposing surface H1A. This makes it possible to prevent a problem of adhesion of magnetic particles attributable to exposure of the adhesion layer 30 at the medium opposing surface H1A.

An adhesive agent injected into the gap between the groove 16 formed in the first core 11 and the bonding surface 25a of the second core 25 may slightly oozes out, due to the capillary phenomenon or the like, between the first abutting plane 14 formed on the first core 11 and the bonding surface 25a of the second core 25. In such a case also, exposure of the adhesive agent on the medium opposing surface H1A can be prevented.

Thickness t1 of the adhesion layer 30 preferably ranges from 0.05 μm to 0.3 μm. The experimental results to be discussed hereinafter have revealed that a core transverse rupture strength of 2N or more can be obtained even in an adverse environment with high humidity if the adhesion layer 30 is formed to a thickness within the aforesaid range.

In the embodiment shown in FIG. 1, the MR thin film magnetic head has been used as the reproducing head for the thin film magnetic head 12. The present invention, however, is not limited to MR thin film magnetic heads and any other magnetic reproducing means may be used for the thin film magnetic head 12. In the embodiment shown in FIG. 4, the recording inductive head 23 made of a thin film is deposited on the MR thin film magnetic head 12. However, the inductive head 23 may be omitted, or the MR thin film magnetic head 12 may be omitted and only the inductive head 23 may be formed.

As shown in FIGS. 1, 2 and 4, the thin film magnetic head 12 and the first core 11 whereon the thin film magnetic head 12 is not formed are covered by the insulating layer 24 providing a protective film. This arrangement prevents the bonding surface 25a of the second core 25 from being directly butted onto the thin film magnetic head 12, thus protecting the thin film magnetic head 12 from damage or the like when the first core 11 and the second core 25 are butted to each other. The groove 16 is formed within the thickness of the insulating layer 24, as shown in FIG. 2. The groove 16, however, may alternatively be extended to the first core 11 made of alumina-titanium carbide under the insulating layer 24.

Since the adhesion layer 30 is formed of an epoxy-based adhesive agent, the bonding process can be implemented at 300° C. or less, thus restraining deterioration of the characteristics of the MR thin film magnetic head 12. The adhesion layer 30 may be formed using a low-melting, glassbased adhesive agent in place of an epoxy-based adhesive agent.

FIG. 3 shows an embodiment in which the abutting plane on the bonding surface 11b of the first core 11 is located at a different position from that shown in FIGS. 1 and 2.

As described above, in the embodiment shown in FIG. 3, the first abutting plane 14 extends in the height direction (direction Y in the drawing) from the medium opposing surface H1A to have a predetermined width (the dimension in direction X) and a length (the dimensional in direction Y) to include the region A wherein the thin film magnetic head 12 is formed, the first abutting plane 14 jutting out toward the bonding surface 25a of the second core 25, as in the embodiment shown in FIGS. 1 and 2.

Referring to FIG. 3, the bonding surface 11b of the first core 11 has three abutting planes 30, 31 and 32 in addition to the first abutting plane 14. The abutting plane 30 is formed toward the inside of the first core 11 from a left end 11c of the first core 11, while the abutting plane 31 is formed toward the inside of the first core 11 from a right end lid of the first core 11. The abutting plane 32 is formed substantially at the middle between the left end 11c and the right end lid of the first core 11.

These abutting planes 14, 30, 31 and 32 are all formed to have the same height, and an electrode surface 34 which is flush with the abutting planes is protuberantly formed at a position away from the abutting planes in the height direction (direction Y in the drawing). The electrodes 13 shown in FIGS. 1 and 2 are formed on the electrode surface 34. A groove 33 is formed to a predetermined depth through the intermediary of steps from the abutting planes 14, 30, 31 and 32 and the electrode surface 34.

The one-dot chain line shown in FIG. 3 denotes the position where a rear end surface 25b of the second core 25 at the farther side from the medium opposing surface H1A is disposed when the first core 11 and the second core 25 are bonded. The rear end surface 25b of the second core 25 is positioned more closely to the medium opposing surface H1A than the electrode surface 34 formed on the first core 11. As a result, the four abutting planes 14, 30, 31 and 32 formed on the first core 11 are butted to the bonding surface 25a of the second core 25, and the first core 11 and the second core 25 are bonded by an adhesive agent injected into the groove 33.

A plurality of the small abutting planes 14, 30, 31 and 32 shown in FIG. 3 and the bonding surface 25a of the second core 25 are planarly bonded, and the bonding surface 25a of the second core 25 does not overlap the electrode surface 34 having a large planar area. These small abutting planes 14, 30, 31 and 32 can be planarly machined with high accuracy, allowing the first core 11 and the second core 25 to be planarly bonded with high accuracy.

The minimum required number of the abutting planes is one, and the abutting plane or planes may be formed at an arbitrary position or positions. Furthermore, in FIG. 1 through FIG. 3, the abutting planes and the groove are formed on the bonding surface 11b of the first core 11. The abutting planes and the groove may alternatively be formed on the bonding surface 25a of the second core 25, or the abutting planes and the groove may be provided on both bonding surfaces 11b and 25a of the first core 11 and the second core 25, respectively.

FIG. 6 through FIG. 11 illustrate the steps of a manufacturing method for the magnetic head shown in FIG. 1. Referring first to FIG. 6, a ground layer composed of an insulating material, such as Al₂O₃ or SiO₂, is formed to a thin film by sputtering on a first substrate 40 composed of alumina-titanium carbide. Then, the thin film magnetic head 12 constructed of the MR thin film magnetic head 22 and the inductive head 23 explained in conjunction with FIG. 4 is formed to a thin film on the ground layer. Alternatively, only the MR thin film magnetic head 22 may be formed to a thin film. Furthermore, the magnetic head used is not limited to the MR thin film magnetic head; a different type may be used as long as it is a magnetic reproducing head.

After the inductive head 23 is formed, the insulating layer 24, which is a protective film composed of Al₂O₃, is formed to a thin film by sputtering. Furthermore, as illustrated in FIG. 6, the electrodes 13 connected in conduction to the MR thin film magnetic heads 22 and the inductive heads 23 are formed on the insulating layer 24.

FIG. 6 shows only some of the thin film magnetic heads 12 and the electrodes 13 formed on the entire surface of the first substrate 40 with predetermined intervals provided among them.

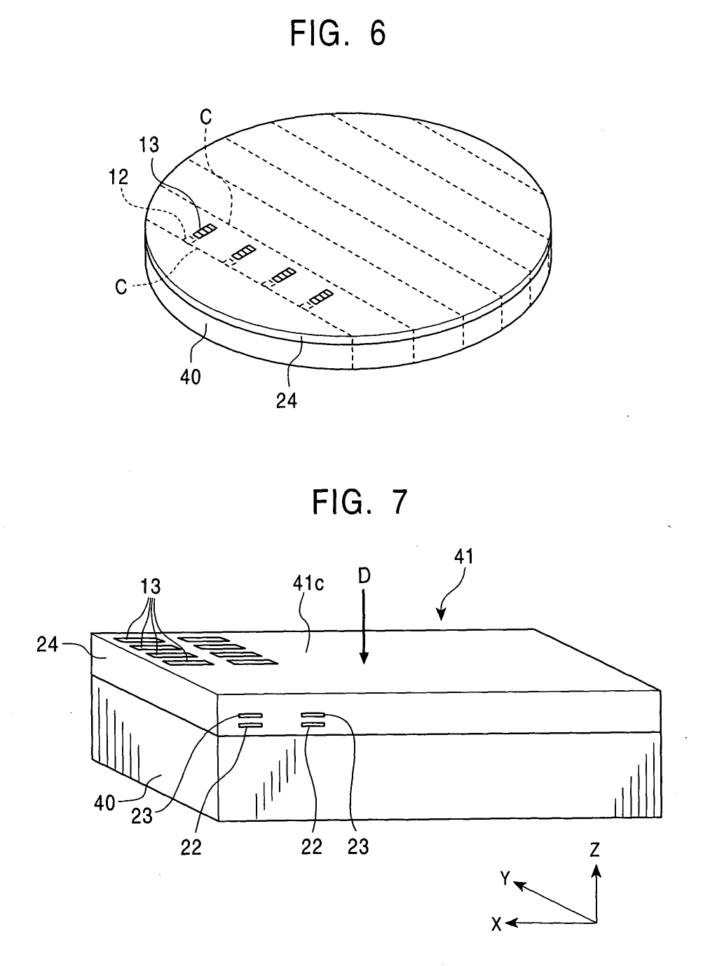

Then, the first substrate 40 is cut into bars along dotted lines C shown in FIG. 6 to make a plurality of first bars 41 shown in FIG. 7. As can be understood from FIG. 7, the first bar 41 has a plurality of the MR thin film magnetic heads 22 and the inductive heads 23 arranged in alignment in the lengthwise direction (direction X in the drawing).

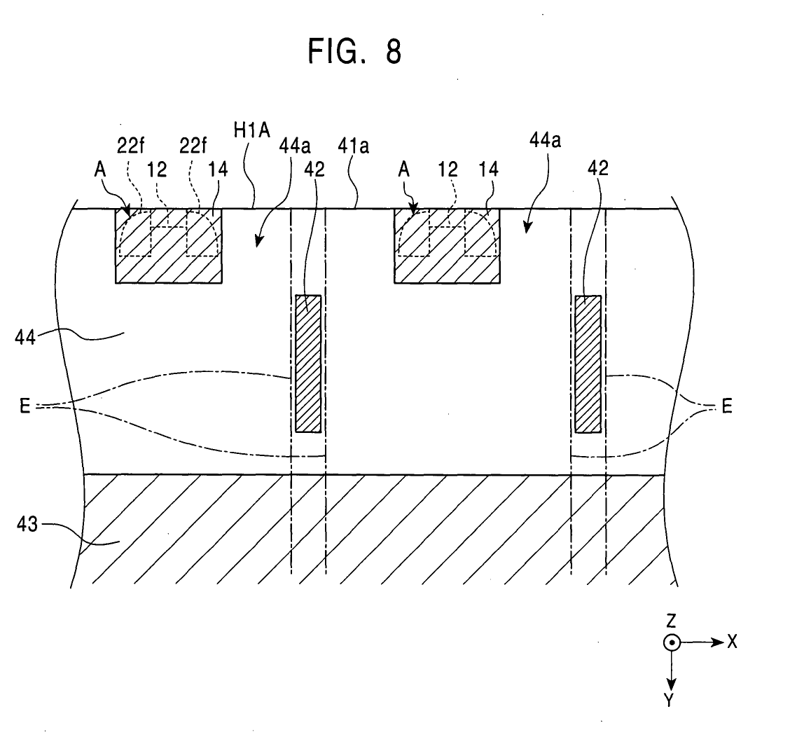

Subsequently, the surface of the first bar 41 shown in FIG. 7 on which the electrodes 13 have been formed (the surface will be referred to as a “bonding surface 41c” hereinafter) is machined as shown in FIG. 8. In this embodiment, the bonding surface 41c denotes the surface of the insulating layer 24.

FIG. 8 is a partial top plan view of the first bar 41 shown in FIG. 7 observed from the direction indicated by an arrow D. As shown in FIG. 8, the first abutting plane 14 that includes the region A wherein the thin film magnetic heads 12 have been formed is protuberantly formed. In addition, dummy pads 42 are protuberantly formed at positions in the regions that are located in direction X with respect to the thin film magnetic heads 12 and are away in direction Y from the surface that will provide the medium opposing surface H1A in a later step. The definition of the region A is as given above.

An electrode surface 43 is protuberantly formed at position further away in direction Y than the dummy pads 42 from the surface that will provide the medium opposing surface H1A in a later step. On the electrode surface 43, the electrodes 13 shown in FIG. 7 are formed at positions distanced in direction Y. The first abutting plane 14, the dummy pads 42 and the electrode surface 43 are all formed to be flush.

Referring to FIG. 8, the first abutting plane 14, the dummy pads 42 and the electrode surfaces 43 are protuberantly formed by first depositing a resist layer on a surface on which they are to be formed, then etching the surface of the insulating layer 24 that is not covered by the resist layer to a predetermined depth. A groove 44 of a predetermined depth is formed in the etched insulating layer 24.

As shown in FIG. 8, it is preferable that the first abutting plane 14 be protuberantly formed to include the region A in which the thin film magnetic heads 12 have been formed.

Forming the first abutting plane 14 to include the region A protect the thin film magnetic heads 12 from the aforesaid etching, making it possible to maintain good reproducing characteristics of the MR thin film magnetic heads 22 and good recording characteristics of the inductive heads 23.

Furthermore, the first abutting plane 14 is formed at a position away from a front end surface 41a of the first bar 41, which will be the medium opposing surface H1A in a subsequent process, in direction Y and also machined so that the groove 44 will not be exposed at the medium opposing surface H1A in a subsequent step. Hence, the adhesive agent injected into the groove 44 will not be exposed at the medium opposing surface H1A, making it possible to prevent magnetic particles sticking to the adhesive agent at the medium opposing surface H1A.

Preferably, as shown in FIG. 8, the first abutting plane 14 is individually formed in the region A of each thin film magnetic head 12 formed on the first bar 41, and a groove 44a formed in direction X between the first abutting planes 14 is made exposed up to the front end surface 41a of the first bar 41. With this arrangement, when the first bar 41 and the second bar 46 are butted against each other to position them, an adhesive agent injected into the groove 44 easily spreads evenly in the groove 44 due to the capillary phenomenon, allowing the first bar and the second bar to be firmly secured by bonding. Furthermore, an adhesive agent can be easily injected through the exposed grooves 44a, so that it is unnecessary to apply the adhesive agent to a bonding surface of either the first bar 41 or the second bar 46 beforehand when butting the two bars to each other. This makes it possible to butt the first bar 41 and the second bar 46 to each other to position them with high accuracy, then to inject the adhesive agent.

Referring again to FIG. 8, as in the case of the first abutting plane 14, the dummy pads 42 that have planes of a predetermined area and are flush with the first abutting plane 14 are formed between the thin film magnetic heads 12 arranged in the longitudinal direction (in direction X) of the first bar 41. The dummy pads 42 are on cutting lines E for along which the first bar 41 and the second bar 46 are cut into cores in a subsequent process, meaning that the dummy pads 42 are removed in the subsequent cutting process. Providing the dummy pads 42 in the longitudinal direction, in which the thin film magnetic heads 12 are arranged, between the thin film magnetic heads 12 makes it possible to evenly distribute the force applied when the first bar 41 and the second bar 46 are butted against each other, restraining an undue force from being applied to the first abutting plane 14 on which the thin film magnetic heads 12 are formed. Thus, good reproducing and recording characteristics of the thin film magnetic heads 12 can be maintained, and the planar bondability of the first bar 41 and the second bar 46 can be improved. The dummy pads 42 provided between the thin film magnetic heads 12 in the longitudinal direction in which the thin film magnetic heads 12 are arranged make it possible to form the groove 44, which is defined by the first abutting plane 14, the dummy pads 42 and the electrode surface 43, into a substantially rectangular shape with a large area. This arrangement allows the adhesive agent to uniformly spread in the entire groove 44 due to the capillary phenomenon.

The dummy pads 42 shown in FIG. 8 are all removed when the first bar 41 and the second bar 46 are cut into cores. The dummy pads 42, however, can be partly left in the first core 11 by setting the width of the dummy pads 42 in direction X to be larger than the interval between the cutting lines E.

If the abutting plane 14 and the dummy pads 42 shown in FIG. 8 are provided at least two or more at the same height adjacently to the first bar 41, and the abutting plane and the dummy pads are preferably arranged at regular intervals in the longitudinal direction (direction X), then the planar bondability for butting the first bar 41 and the second bar 46 to each other can be further improved. This allows the bars to be set parallel to each other easily and properly, and also allows adhesion layers 47 to be easily formed to a predetermined thickness when producing it by injecting an adhesive agent.

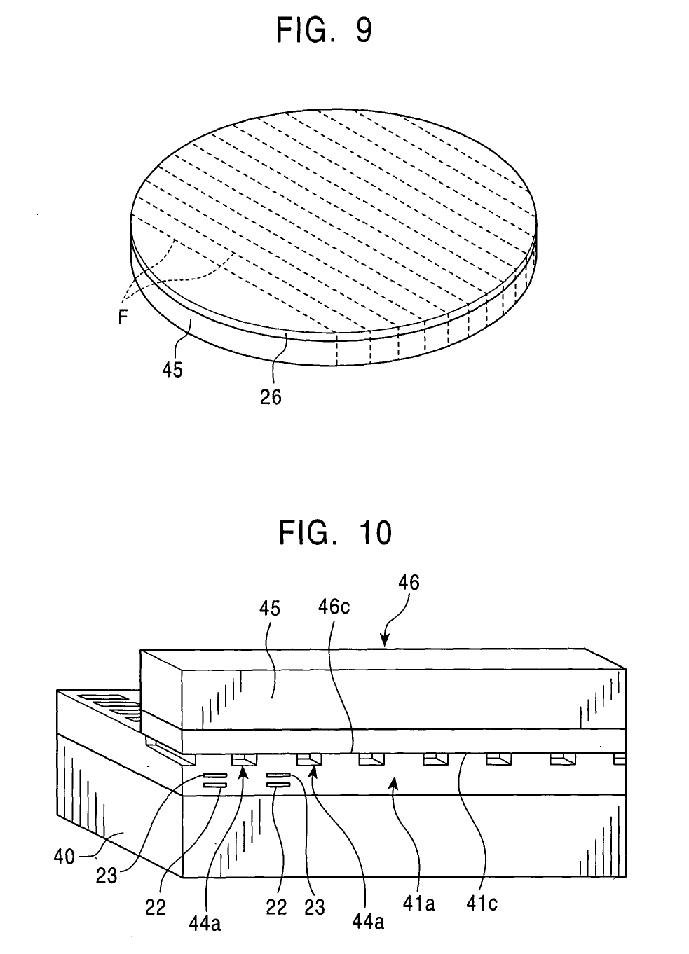

In the step illustrated in FIG. 9, an insulating layer 26 is deposited by sputtering on a second substrate 45 composed of alumina-titanium carbide, then the second substrate 45 is cut along dotted lines F shown in FIG. 9 to make a plurality of bar-shaped second bars 46.

Referring to FIG. 10, the surface of the first bar 41 on which the thin film magnetic heads 12 are formed is defined as the bonding surface 41c, while the surface of the insulating layer 26 of the second bar 46 is defined as a bonding surface 46c. These bonding surfaces 41c and 46c are butted to each other. In the butting step, for example, an adhesive agent is injected into the groove 44 formed in the first bar 41 beforehand, and the first abutting plane 14 and the dummy pads 42 formed on the bonding surface 41c of the first bar 41 and the electrode surface 43 are partly butted to the bonding surface 46c of the second bar 46. This causes the adhesive agent in the groove 44 to evenly spread in the groove 44 due to the capillary phenomenon.

As shown in FIG. 10, the groove 44a constituting the groove 44 is opened at the front end surface 41a of the first bar 41, so that the adhesive agent injected into the groove 44 spreads in the groove 44 more evenly and quickly by the capillary phenomenon when the first bar 41 and the second bar 46 are butted to each other. Alternatively, the first bar 41 and the second bar 46 may be first positioned with high accuracy, and then an adhesive agent may be injected through the grooves 44a exposed on the front end surface 41a. Thereafter, the adhesive agent is cured by heating so as to bond the first bar 41 and the second bar 46 by the adhesion layers 47.

In this embodiment, since an epoxy-based adhesive agent is used as the aforesaid adhesive agent, the bonding process can be implemented at 300° C. or less, thus restraining deterioration of the characteristics of the MR thin film magnetic heads 12. The adhesion layers 47 may be formed using a low-melting, glass-based adhesive agent in place of an epoxy-based adhesive agent.

In the step illustrated in FIG. 8, the groove 44 is formed to have a constant depth ranging from 0.05 μm to 0.3 μm, so that the adhesion layers 47 can be formed to have a constant thickness ranging from 0.05 μm to 0.3 μm accordingly. The experiment results to be discussed later have indicated that a core transverse rupture strength of 2N or more can be obtained even in a highly humid environment if the adhesion layers 47 are formed to a thickness within the aforesaid range. Therefore, high bonding strength of the adhesion layers 47 can be maintained.

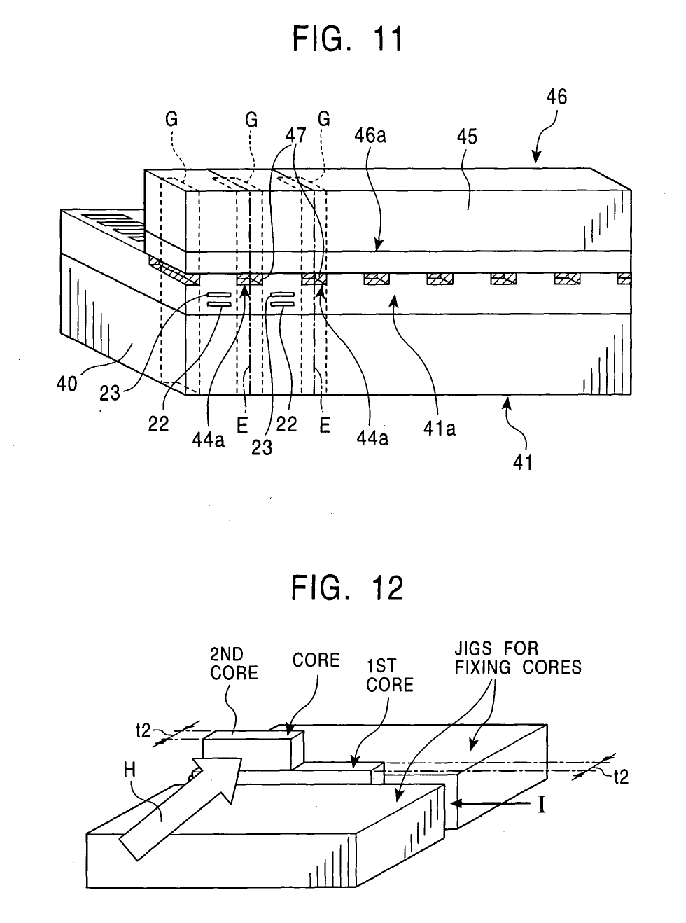

In the step illustrated in FIG. 11, the grooves 44a with their ends exposed on the front end surface 41a of the first bar 41 have been filled with the adhesive agent, so that the adhesion layers 47 are exposed on the front end surface 41a. The first bar 41 and the second bar 46 are ground along dotted lines G such that the exposed portions of the adhesion layers 47 are also ground so as to form the recessed portions 19 and 20 (shown in FIG. 1) in the first bar 41 and the second bar 46, respectively. Once the recessed portions 19 and 20 are formed, the front end surfaces 41a and 46a of the first bar 41 and the second bar 46, respectively, no longer have any portion where the adhesion layers 47 are exposed.

Then, the first bar 41 and the second bar 46 are cut into cores along one-dot chain lines E shown in FIG. 11 so as to produce magnetic heads, each including the first core 11 and the second core 25 bonded by the adhesion layer 47. Furthermore, the medium opposing surface H1A of the magnetic head is subjected to cylindrical grinding or copy grinding to a radium shape. This fabricates a magnetic head having the magnetic gap G of the thin film magnetic head 12 exposed on the medium opposing surface H1A of the first core 11 and the second core 25.

The following will describe the experiments carried out to determine a preferable range of thickness of the adhesion layer lying between the first core and the second core.

First, as shown in FIG. 12, a first core shaped in a rectangular parallelepiped and a second core that is also shaped in a rectangular parallelepiped but is shorter than the first core were bonded with an adhesion layer provided therebetween. The shapes of the bonding surfaces of the first core and the second core are the same as those shown in FIGS. 1 and 2. About 95% to 96% of the area of the bonding surface of the first core is occupied by a groove, and the remaining area of 5% to 4% is occupied by a first abutting plane that includes the region wherein thin film magnetic heads are formed. The first core was produced as explained in conjunction with FIG. 8. The first bar, as shown in FIG. 8, was formed, and the first core was made from the first bar. When the area of the surface to be bonded to the second bar is taken as 100%, the area of the abutting plane in the first bar occupies about 20% and the groove occupies the remaining 80%.

Referring to FIG. 12, both side surfaces of the first core were secured by fixing jigs, and a force was applied in the direction indicated by the arrow H to a side surface of the second core to measure the pressure at which the first core and the second core broke, which will be referred to as “the transverse rupture strength of the core.” Thickness t2 of the first core and the second core was set to 0.23 μm. An epoxy-based resin was used for the adhesion layer.

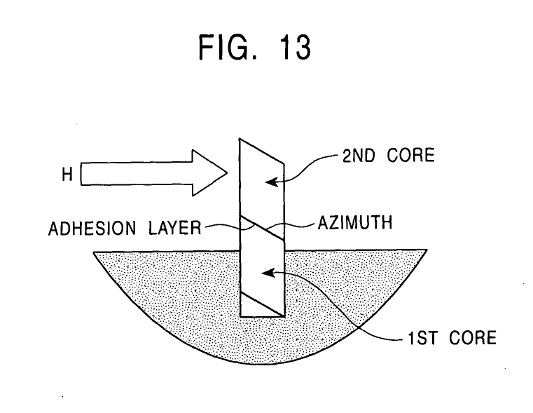

FIG. 13 is a partial side view of the portion of the first core clamped between the fixing jigs shown in FIG. 12, which is observed from the direction indicated by the arrow I. As shown in FIG. 13, the first core and the second core have azimuths. The force was applied to the side surface of the second core at about 0.1 μm above the center of the adhesion layer. The direction H in which the force was to be applied was set such that the azimuths gradually shift away in relation to the direction H.

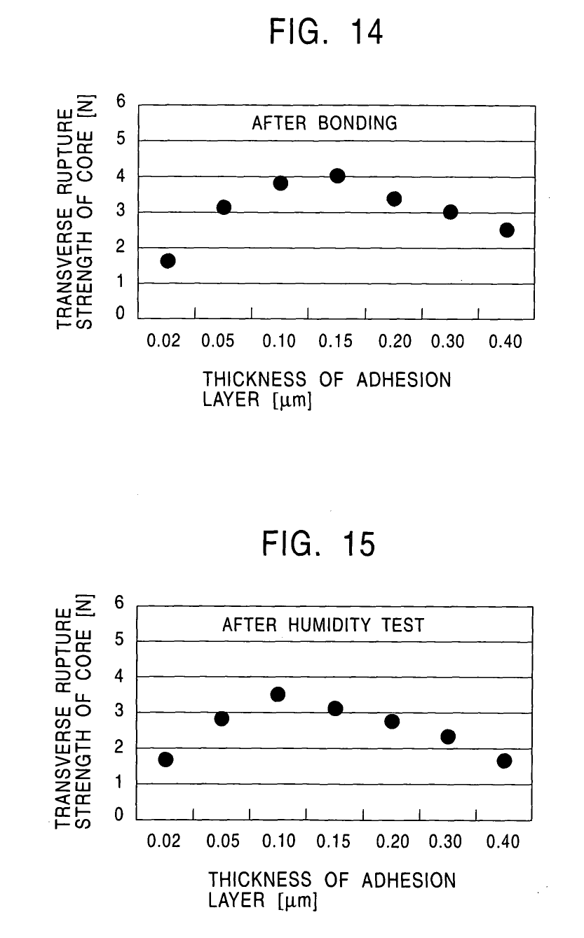

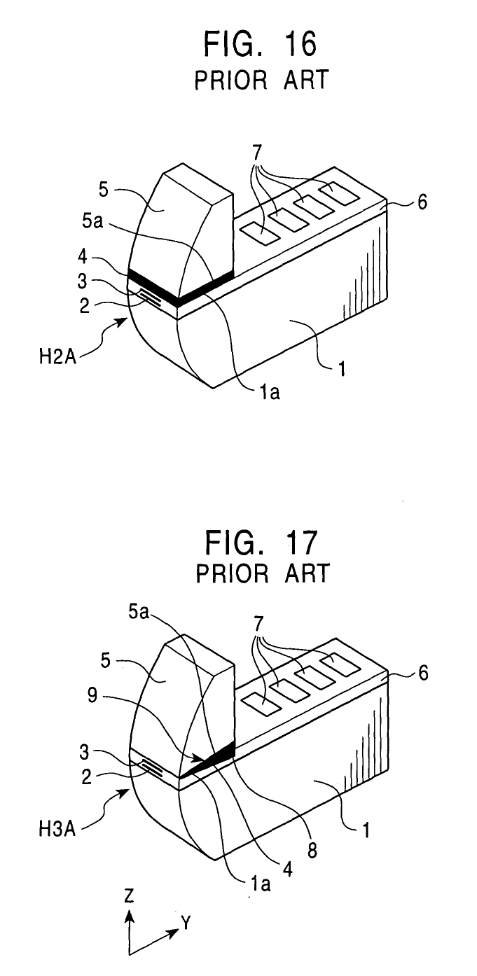

FIG. 14 is a graph showing the relationship between the thickness of the adhesion layer and the transverse rupture strength of the cores immediately after the first core and the second core were bonded. FIG. 15 is a graph showing a relationship between the thickness of the adhesion layer and the transverse rupture strength of the cores after the first core and the second core bonded by the adhesion layer were left for 72 hours in an environment wherein the room temperature is 40° C. and humidity is 95%.

The graph shown in FIG. 14 indicates that the highest transverse rupture strength of the cores is observed when the thickness of the adhesion layer is about 0.15 μm, and that the transverse rupture strength of the cores gradually decreases as the adhesion layer is thinner or thicker than 0.15 μm.

The graph shown in FIG. 15 indicates that the transverse rupture strength of the cores is the highest when the adhesion layer is about 0.10 μm, and gradually decreases as the adhesion layer is thinner or thicker than 0.10 μm.

The transverse rupture strength of the cores decreases as the thickness of the adhesion layer reaches a certain point probably because moisture infiltrates into the adhesion layer more easily especially in a highly humid environment.

The transverse rupture strength of the cores of 2N or more will protect the cores from breakage, and it should not be 1N or less when the magnetic head is actually used. Hence, the thickness of the adhesion layer was set to the range of 0.05 μm to 0.3 μm. This allows the transverse rupture strength of the cores to be maintained at 2N or more.

What is claimed is:

1. A magnetic head comprising:
a first core having a thin film magnetic head; and
a second core bonded to the first core from a surface whereon the thin film magnetic head is formed,
a magnetic gap of the thin film magnetic head being exposed on a medium opposing surface of the first core and the second core,
wherein a bonding surface of at least one of the first core and the second core is provided with at least one abutting plane that juts out toward the other bonding surface and a groove formed to have a predetermined depth with a step provided between itself and the abutting plane,
the abutting plane and the bonding surface of the other core are butted against each other,
an adhesion layer of a predetermined thickness is provided at least between the groove and the bonding surface of the other core, and
the first core and the second core are bonded.

2. The magnetic head according to claim 1, wherein the abutting plane is formed such that it includes the region formed on the first core wherein the thin film magnetic head is formed.

3. The magnetic head according to claim 1, wherein the thickness of the adhesion layer ranges from 0.05 μm to 0.3 μm.

4. The magnetic head according to claim 1, wherein the thin film magnetic head is constructed to have an MR thin film magnetic head.

5. The magnetic head according to claim 1, wherein the thin film magnetic head and the first core are covered with a protective film made of an insulating material, and the front surface of the protective film provides the bonding surface.

6. The magnetic head according to claim 1, wherein the adhesion layer is formed of an epoxy-based adhesive agent or a low-melting, glass-based adhesive agent.

7. A manufacturing method for a magnetic head comprising the steps of:
(a) forming a plurality of thin film magnetic heads on a first substrate, then cutting the first substrate into a bar with a plurality of thin film magnetic heads aligned thereon in the longitudinal direction to form a first bar;
(b) cutting a second substrate into a bar to form a second bar;
(c) defining the surface of the first bar whereon the thin film magnetic heads are formed as the surface to be bonded to the second bar, protuberantly forming at least one or more abutting planes on the boding surface of at least one of the first bar or the second bar at positions where they will remain in cores when the bars are cut into individual cores in a subsequent step, and forming a groove with a predetermined depth with a step provided between itself and the abutting plane,
(d) abutting the abutting plane formed on at least one bar against the bonding surface of the other bar, setting the bars in parallel to each other, and forming an adhesion layer of a predetermined thickness between the groove formed in at least one bar and the bonding surface of the other bar to bond the first bar and the second bar; and
(e) cutting the first bar and the second bar into cores at between the individual thin film magnetic heads to produce a magnetic head having the first core and the second core bonded through the intermediary of the adhesion layer and a magnetic gap of the thin film magnetic head being exposed on the medium opposing surface of the first core and the second core.

8. The manufacturing method for a magnetic head according to claim 7, wherein in the step (c), the abutting plane is formed such that it includes the region wherein the thin film magnetic heads of the first bar are formed.

9. The manufacturing method for a magnetic head according to claim 8, wherein in the step (c), the abutting plane is formed in each region wherein the thin film magnetic heads are formed, and the groove formed between the abutting planes is exposed up to the front end surface of the first bar that will provide a medium opposing surface.

10. The manufacturing method for a magnetic head according to claim 7, wherein in the step (c), the abutting planes are formed in the region between the thin film magnetic heads arranged in the longitudinal direction of the first bar.

11. The manufacturing method for a magnetic head according to claim 10, wherein the abutting planes formed between the thin film magnetic heads are dummy pads located on cutting lines for cutting the first bar and the second bar into cores in the step (e), and all or some of the dummy pads are removed by the cutting.

12. The manufacturing method for a magnetic head according to claim 7, wherein the groove is formed to a depth ranging from 0.05 μm to 0.3 μm in the step (c) to form the adhesion layer to a thickness ranging from 0.05 μm to 0.3 μm in the step (d).

13. The manufacturing method for a magnetic head according to claim 7, wherein an epoxy-based adhesive agent or a low-melting, glass-based adhesive agent is selected as an adhesive agent in the step (d).
